(19) United States
(12) Patent Application Publication
(10) Pub. No.: US 2020/0184791 A1
(43) Pub. Date: Jun. 11, 2020

(54) FINGERNAIL-ATTACHABLE COVERT COMMUNICATIONS SYSTEM

(71) Applicant: Floyd Steven Hall, JR., Sacramento, CA (US)

(72) Inventor: Floyd Steven Hall, JR., Sacramento, CA (US)

(21) Appl. No.: 16/212,692

(22) Filed: Dec. 7, 2018

(51) Int. Cl. G08B 21/02; G06F 3/01; G08B 6/00

(52) U.S. Cl. CPC G08B 21/02; G08B 6/00; G06F 3/017; G06F 3/014

(57) ABSTRACT

A fingernail-attachable covert communications system that enables a victim to capture evidence electronically, and communicate that evidence electronically, while said victim is in the process of being victimized, without the perpetrator knowing that the communications is occurring.

### FIELD OF INVENTION

The technical field relates generally to technology for persons who are blind or visually impaired. However, users of the present invention will be the general public, where the general public includes, but is not limited to, persons who are blind or visually impaired.

### DESCRIPTION OF PRIOR ART

When a victim is in the process of being victimized, a perpetrator will not knowingly allow said victim to capture evidence electronically, or freely communicate electronically. As a result, said perpetrator will not allow said victim to use conspicuous prior art devices having video display screens, which include, but is not limited to, smartphones, smartwatches, and tablets. Also, said perpetrator will usually remove other visible prior art devices, that may contain hidden cameras or microphones, which include, but is not limited to, jewelry, keyrings, and personal alarm devices.

What is needed is a covert communications device that said perpetrator would not know said victim is wearing. In addition, said victim needs to be able to operate said covert communications device even when the movements and senses of said victim are severely impaired or restricted. Examples of how the movements and/or senses of said victim can be severely impaired or restricted include, but is not limited to, the following: cannot see (e.g. blindfolded), cannot speak (e.g. mouth taped), cannot hear (e.g. hooded), cannot hold objects (e.g. police officer yells drop what's in your hands), hands bound together (e.g. handcuffed, roped, taped), and/or hands bound apart (e.g. right hand bound to right side of brass headboard, and left hand bound to left side of brass headboard).

Thus, there is a widely recognized need for, and it would be highly advantageous to have, said covert communications device that enables said victim to collect evidence electronically, and communicate electronically with others, while the act of being victimized is in progress.

### SUMMARY OF THE INVENTION

The present invention is beneficial to a victim is many different victimization circumstances, which include, but is not limited to, the following:
Domestic Violence
Schoolyard Violence
Bullying/Intimidation/Threats
Robbery/Mugging
Physical Assault
Sexual Assault
Sexual Harassment
Police Harassment/Police Misconduct
Workplace Harassment
Sexual Discrimination
Racial Discrimination
Religious Discrimination
Sexual Orientation Discrimination
Date Rape
Abduction/Kidnapping

The present invention is for a covert communications device that a perpetrator would not know a victim is wearing, and where said victim can operate said covert communications device, even when the movements and/or senses of said victim are severely impaired or restricted. An embodiment disclosed of the present invention is a refreshable tactile communications means, further including a fingernail-attachable holder means and a camera means. To enhance concealment, at least one said means (or a portion thereof), included with said embodiment disclosed of the present invention, is made of at least one material that is transparent, semi-transparent, or easily concealable because of its size, shape, color, or a combination thereof.

One of a plurality of possible embodiments of said refreshable tactile communications means, which can include, but is not limited to:
a refreshable tactile display means operative to receive one or more control signals for controlling selectively movable tactile dots, and displaying therefrom tactile data to be read by a fingertip of a victim;
a Printed Circuit Board (PCB), coupled to the underside of said refreshable tactile display means; and
a tray holder means, capable of holding said PCB inside said tray holder means, attaches to said refreshable tactile display means.

Said PCB can include, but is not limited to, the following:
a motion sensing means operative to generate one or more signals indicative of an orientation in space, or a change of orientation in space;
a memory means operative to receive one or more control signals for controlling the location within the memory means, and to generate one or more signals corresponding to data stored at the location representative of said control signals;
a processor means having at least one input coupled to an output of the motion sensing means, the processor means receiving, via at least one bus, the one or more signals therefrom and generating corresponding control signals for controlling a location in the memory means, the processor means having at least one input coupled to an output of the memory means, the processor means receiving, via at least one bus, the one or more signals therefrom indicative of the data stored at the location, the processor means having at least one output coupled to said refreshable tactile display means and generating corresponding control signals output to said refreshable tactile display means, for displaying the data stored at the location corresponding to the motion;
a transceiver means operative to provide communications with external devices and systems to at least one means, where said transceiver means is capable of using one or more of cellular, satellite, Wi-Fi, and Bluetooth™ protocols, or any other appropriate communications protocols;
a power means operative to provide power to at least one means;
a transducer means;
a button means and/or a speaker means and/or a microphone means or combination thereof;
a payments means;
additional sensor means, and/or analyzer means, or a combination thereof.

Said fingernail-attachable holder means can include, but is not limited to, a power means.

Said camera means can include, but is not limited to, the following:
at least one camera;
at least one microphone;
a transceiver means;
a power means, operative to provide power to at least one means; and
at least one bus.

In said embodiment disclosed of the present invention, the focus of said motion sensing means will be on changes in angular motion. When said victim changes the angular motion of said refreshable tactile communications means, said victim effects a corresponding movement of the location within said memory means. Said changes in angular motion is referred to as yaw, pitch, and roll. Said processing means controls or executes, at least partially, the functions required for operating said refreshable tactile communications means. Said embodiment disclosed of the present invention can further include a payments means, for making wireless payments, when a victim has to escape quickly from a perpetrator, enabling said victim to pay for essentials, which can include, but is not limited to, food, clothing, shelter, and transportation.

Said fingernail-attachable holder means defines generally the overall shape of said embodiment disclosed of the present invention, and holds, supports and/or protects said refreshable tactile communications means and said camera means, and optionally, a neural interface means, where the use of said neural interface means can include, but is not limited to, operating said refreshable tactile communications means. Said fingernail-attachable holder means includes at least one communications slot, where said refreshable tactile communications means, and/or said neural interface means, can be removeably inserted. Said fingernail-attachable holder means includes a camera slot, used to secure said camera means to said fingernail-attachable holder means. Furthermore, said camera slot enables said victim to extend said camera means beyond the fingertip, thus enabling said camera means to provide enhanced visibility of the surroundings of said victim.

One of a plurality of possible embodiments of said camera means can include, but is not limited to, the following:
a camera holder means;
at least one camera;
at least one microphone;
a transceiver means;
a power means;
an attachment means;

Said camera holder means defines generally the overall shape of said camera means, and holds, supports and/or protects cameras, microphones, said transceiver means, said power means, and said attachment mean. The cameras can include, but is not limited to, at least one daytime camera (for daylight), and at least one nighttime camera (for nightlight). The act of extending said camera means instructs said refreshable tactile communications means to start transmitting live audio video data, received from said camera means, directly to Internet-accessible storage, where said refreshable tactile communications means uses its phone-capable transceiver means to communicate directly with the Internet, using the phone network. The evidence collected is stored remotely, out of reach of said perpetrator. Examples of vendors of Internet-accessible storage include Dropbox, Box, Google Drive, and OneDrive by Microsoft.

In one embodiment of the present invention, said victim can create, in advance, a list of persons allowed to access the evidence collected, and who will be notified, automatically, when evidence is deposited into Internet-accessible storage. Each such person is referred to herein as a designated recipient. Said designated recipient can include, but is not limited to, a family member, a friend, a lawyer, a reporter, a coworker, a police department, and/or a public website (e.g. YouTube). In said embodiment disclosed of the present invention, said designated recipient can review the evidence collected, and provide real-time feedback to said victim. This feedback can include, but is not limited to, a text message, a phone call, and/or a money transfer to said payments means.

A device finger means the finger that contains the fingernail upon which said device is attached. A slide finger means the finger used, by said victim, to extend or retract said camera holder means. Live streaming of audio video data is initiated when said camera holder means is fully extended. Covert communications between family and/or friends, and said victim, can include, but is not limited to, textual messages. In order to read, covertly, said covert textual message, said victim places a fingertip in contact with said refreshable tactile display means, in order to “feel” the character patterns scrolling across said refreshable tactile display means. The finger, containing the fingertip used for tactile reading, is referred to herein as a reading finger.

One of a plurality of possible embodiments of the present invention enables said victim to make and/or receive phone calls. In one embodiment, to listen to an incoming phone call, said victim places said knuckle to a bone on the head of said victim, where said bone on the head can include, but is not limited to, a cheekbone. The vibration generated by said device are transmitted through said device finger, through said knuckle, through said cheekbone, and into the inner ear of said victim. By placing said device near the mouth, said victim can speak during said phone call, using at least one microphone included with said camera means.

Said embodiment disclosed of the present invention can further include a neural interface means, for said refreshable tactile communications means, where said neural interface means is removably inserted into one communications slot, and is coupled to said refreshable tactile communications means, and said fingernail-attachable holder means, and/or said camera means, or any combination thereof.

Said neural interface means can include, but is not limited to, the following:
a neural sensor means;
a neural stimulator means (optional);
a transceiver means;
a power means; and
a bus.

Said neural interface means enables said victim to control said refreshable tactile communications means using the thoughts of said victim. This control can include, but is not limited to, issuing commands, and writing text messages, using the thoughts of said victim. When said victim touches said device finger to the skull, said neural sensor means detects the brainwave emissions from said victim and, using said transceiver means, transmits the brainwave emissions to said refreshable tactile communications means, for processing into thoughts, smell, taste, touch, sight, and sounds.

### SUMMARY OF FIGURES

FIG. 1 illustrates a refreshable tactile communications means

FIG. 2 illustrates block diagrams for the embodiment disclosed

FIG. 3 illustrates a fingernail-attachable holder means

FIG. 4 illustrates the underside of a fingernail-attachable holder means

FIG. 5 illustrates a camera means

FIG. 6 illustrates a device that includes, but is not limited to, a refreshable tactile communications means, a fingernail-attachable holder means, and a camera means

FIG. 7 illustrates the bottom view of the device

FIG. 8 illustrates an example of how to initiate covert communication with device

FIG. 9 illustrates block characters used for tactile reading on device

FIG. 10 illustrates experimentally developed characters used for tactile reading on device

FIG. 11 illustrates an example of how to read a covert text message on device

FIG. 12 illustrates using Yaw and Pitch to navigate the memory means of device

FIG. 13 illustrates using Roll to control auto-scrolling through the memory means

FIG. 14 illustrates how device can be used for covert phone call

FIG. 15 illustrates a neural interface means for the device

FIG. 16 illustrates using a neural interface means to control device

### DETAILED DESCRIPTION

Although the scope of the present invention includes, but is not limited to, fingers, fingernails, toes, and toenails, the discussion that follows will reference only fingers and fingernails, with the understanding that the scope of the present invention includes, but is not limited to, toes and toenails as well. Also, in some embodiments of the present invention, “writing” is accomplished using a combination of “reading” and “selection”.

As used herein, a “means” can be regarded either as an action, or as the hardware for performing the action. In addition, as used herein, the term “connected” “coupled” and any variants thereof can be regarded as any connection or coupling, either direct or indirect, between two or more said means. The connection or coupling between said means may be physical, logical, electrical, chemical, molecular, magnetic, or a combination thereof. Additionally, data communications between the connected or coupled said means can be, but is not limited to, wired, wireless, or a combination thereof.

One of a plurality of possible embodiments of the present invention is discussed below. An embodiment disclosed of the present invention is a refreshable tactile communications means, further including a fingernail-attachable holder means, and further including a camera means. In addition, to enhance concealment, at least one said means (or a portion thereof), included with said embodiment disclosed of the present invention, is made of at least one material that is transparent, semi-transparent, or easily concealable because of its size, shape, color, or a combination thereof. Indeed research, conducted by Dr. Yi Cui, a professor of materials science and engineering and of photon science at SLAC National Accelerator Laboratory at Stanford University, shows that all electronics contained within the present invention can be made transparent. See Cui, Yi, “Stanford transparent batteries: seeing straight through to the future?”, Stanford Report (Jul. 25, 2011); Vieru, Tudor and Cui, Yi, “Stanford Experts Develop Transparent, Flexible Batteries”, Stanford Report (Jul. 26, 2011); and Yang, Yuan and Cui, Yi, “Transparent lithium-ion batteries”, Proceedings of the National Academy of Sciences(PNAS) (Jul. 25, 2011).

Furthermore, the hands of a victim and/or a user of the present invention can be immersed occasionally in substances and/or environments that could affect adversely the operational performance of the present invention. Therefore, said embodiment disclosed of the present invention will use an encapsulation means, to protect at least one said means (or a portion thereof), included with said embodiment disclosed of the present invention, from such substances and/or environments. Household products is one of a plurality of possible examples of such substances and/or environments, where household products can include, but is not limited to, soaps, dishwashing liquids, bleach, ammonia, and cooking oils.

Said encapsulation means may also provide protection against temperature changes of heat and cold. In one embodiment of said encapsulation means, encapsulation can be performed using a coating made of a suitable polymeric material, such as, for example, a hydrogel material similar to that employed for ophthalmic contact lenses. As an example, patent U.S. Pat. No. 8,874,182 B2 discusses one of many possible types of said encapsulation means, where a bio-compatible material, parylene C (e.g., dichlorodi-p-xylylene), is used to form a conformal coating around the means, such as where the layers of bio-compatible material are formed by an evaporation process. The encapsulated means may be peeled away from a working substrate after the portions of the bio-compatible material that wrap around the working substrate are trimmed away (e.g., by etching the annealed layers of bio-compatible material to create an encapsulated structure with a desired shape). The means is encapsulated (sealed) within a bio-compatible material by two layers of the bio-compatible material annealed together to seal the respective overlapping edges.

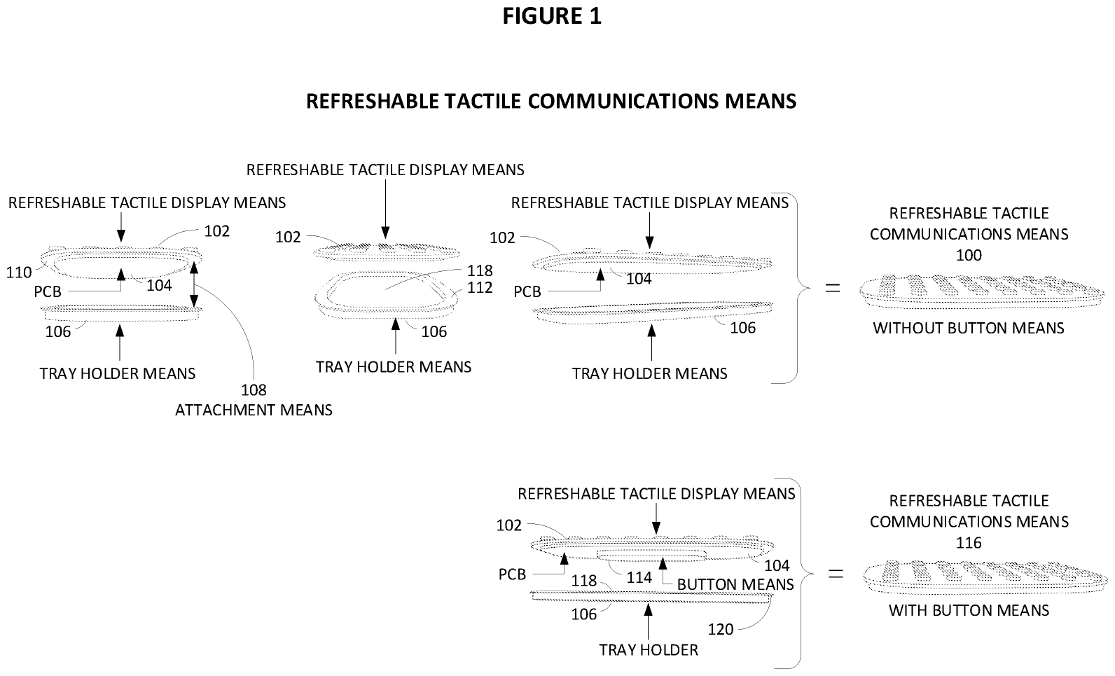

FIG. 1 illustrates one of a plurality of possible embodiments of said refreshable tactile communications means 100, which can include, but is not limited to:
a refreshable tactile display means 102 operative to receive one or more control signals for controlling selectively movable tactile dots, and displaying therefrom tactile data to be read by a fingertip of a victim;
a Printed Circuit Board (PCB) 104, coupled to the underside of said refreshable tactile display means 102; and
a tray holder means 106, capable of holding said PCB 104 inside said tray holder means 106, attaches to said refreshable tactile display means 102 using an attachment means 108 that attaches a lip 110 of said refreshable tactile display means 102 to the upper surface of a lip 112 of said tray holder means 106.

Said attachment means 108 can include, but is not limited to, an adhesive attachment means, a mechanical attachment means, a magnetic attachment means, a molecular attachment means, and a chemical attachment means. Note that other embodiments of the refreshable tactile communications means can exclude said tray holder means 106, and protect said PCB 104 using said encapsulation means.

Said refreshable tactile communications means 100 can further include a button means 114 coupled to said PCB 104, resulting in embodiment 116. In the refreshable tactile communications means 116, said button means 114 can be used for a plurality of possible functions, where said plurality of possible functions can include, but is not limited to, making a Selection, turning ON, and/or turning OFF, the refreshable tactile communications means 116. Said button means 114 typically includes a switch, and uses conventional electronic circuitry. In one embodiment, said button means 114 can be activated by applying sufficient pressure to said refreshable tactile display means 102 to engage said button means 114 against the bottom 118 of said tray holder means 106.

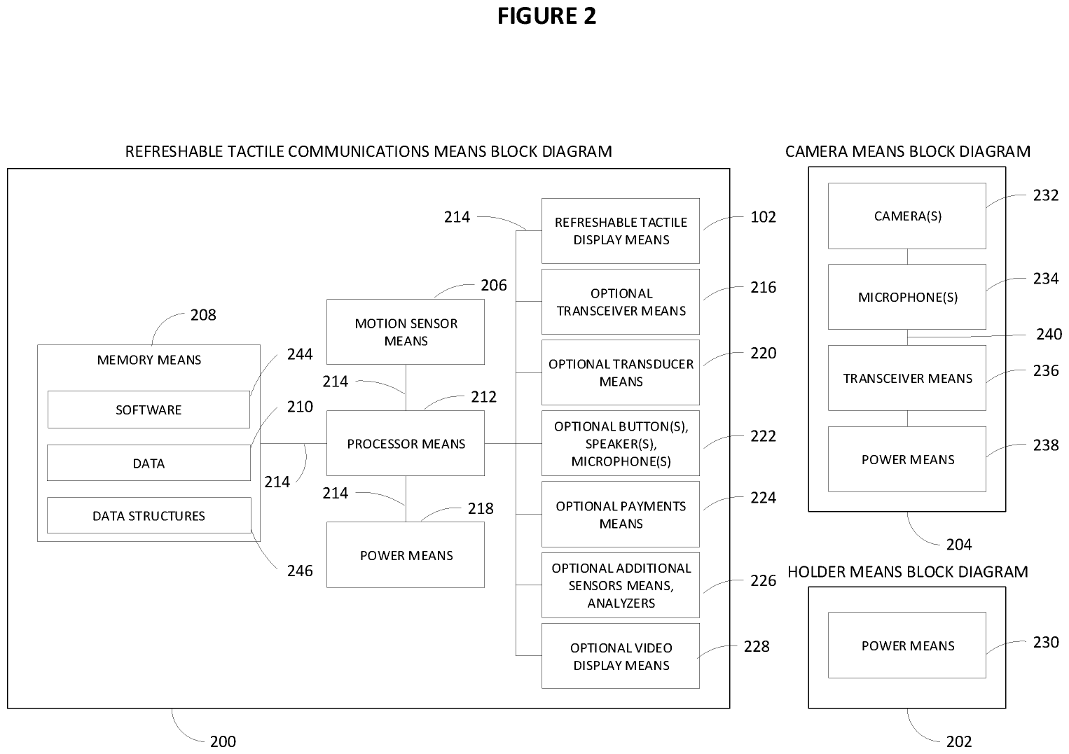

FIG. 2 illustrates a block diagram of said embodiment disclosed of the present invention, which includes a block diagram 200 of said refreshable tactile communications means 100, a block diagram 202 of said fingernail-attachable holder means, and a block diagram 204 of said camera means, where said block diagram 202 of said fingernail-attachable holder means, said block diagram 204 of said camera means, and said block diagram 200 of said refreshable tactile communications means 100, are coupled together.

Said block diagram 200 of said refreshable tactile communications means 100, includes said refreshable tactile display means 102, and said Printed Circuit Board (PCB) 104, where said PCB 104 can include, but is not limited to, the following:
a motion sensing means 206 operative to generate one or more signals indicative of an orientation in space, or a change of orientation in space;
a memory means 208 operative to receive one or more control signals for controlling the location within the memory means 208, and to generate one or more signals corresponding to data 210 stored at the location representative of said control signals;
a processor means 212 having at least one input coupled to an output of the motion sensing means 206, the processor means 212 receiving, via at least one bus 214, the one or more signals therefrom and generating corresponding control signals for controlling a location in the memory means 208, the processor means 212 having at least one input coupled to an output of the memory means 208, the processor means 212 receiving, via at least one bus 214, the one or more signals therefrom indicative of the data 210 stored at the location, the processor means 212 having at least one output coupled to said refreshable tactile display means 102 and generating corresponding control signals output to said refreshable tactile display means 102, for displaying the data 210 stored at the location corresponding to the motion;
a transceiver means 216 operative to provide communications with external devices and systems to at least one means, where said transceiver means 216 is capable of using one or more of cellular, satellite, Wi-Fi, and Bluetooth protocols, or any other appropriate communications protocols;
a power means 218 operative to provide power to at least one means;
a transducer means 220;
a button means and/or a speaker means and/or a microphone means or combination thereof 222;
a payments means 224;
additional sensor means, and/or analyzer means, or a combination thereof 226, where these additional sensor means and/or analyzer means 226 can include, but is not limited to, an environmental sensor means, a bio-sensor means, a health sensor means, a light sensor means, a pressure sensor means, a proximity sensor means, a touch sensor means, radiological sensor means, an electromagnetic spectrum analyzer means, and a gas chromatography means;

In one of a plurality of possible embodiments, the present invention can further include a video display means 228.

Said block diagram 202 of said fingernail-attachable holder means, which includes a holder means PCB, where said holder means PCB can include, but is not limited to, the following:
a power means 230 operative to provide power to at least one means.

The block diagram 204 of said camera means, which includes a camera means PCB, where said camera means PCB can include, but is not limited to, the following:
at least one camera 232;
at least one microphone 234;
a transceiver means 236;
a power means 238, operative to provide power to at least one means; and
at least one bus 240.

In the present invention, the PCB can be either a rigid PCB, or a flexible PCB, where a flexible PCB is more commonly known as flexible electronics.

In said embodiment disclosed of the present invention, at any given time, said victim touches with the fingertip only a small part of the content of said memory means 208, and reconstructs the layout of that content from a sequence of such partial touches. Said memory means 208 can include, but is not limited to, data 210, software 244, and data structures 246. Said data 210 can include, but is not limited to, character sets, text messages, phone numbers, personal identification data, location data, Text Templates (containing common phrases, and personalized phrases, used in different scenarios), bio-sensor data, and graphical data. Said data structures 246 can include, but is not limited to, a Phonebook, a Call Record, a Message Menu, a Help Menu, a Settings Menu, and a Survival Guide.

In regards to said refreshable tactile display means 102, the term “refreshable” is intended to mean that a tactile display means is capable of refreshing or changing over time, either automatically or controllably, an array of selectably movable tactile dots that is displayed to said victim. In said embodiment disclosed of the present invention, said array of selectably movable tactile dots has size and shape configured for tactile engagement by a fingertip.

As known in the art, the electromechanically actuated dots can be moved up and down in response to an electrical signal originating from said processing means, to form different combinations of raised dots representing characters, where the characters can include, but is not limited to, letters, numbers, punctuations, and symbols. It will be understood that embodiments where said refreshable tactile display means 102 need not involve or be based on an electro-mechanical actuation, but could be activated using any other suitable actuation technology (e.g., magnetic or infrared laser radiation), are indeed included within the scope of the present invention. Additionally, it will be understood that said refreshable tactile display means 102 need not be embodied by cells, but could be embodied by any suitable means (e.g., a tactile image screen) capable of presenting, displaying or otherwise outputting tactile content to said victim in a refreshable manner. Moreover, it will be understood that a dot, need not be a pin, but can be an elastic diaphragm, or any other suitable tactile technology capable of forming a lump, which enables said victim to “feel” the data being displayed. Moreover, in one of a plurality of possible embodiments, the elastic diaphragms can be made of a transparent, or semi-transparent, material.

In said embodiment disclosed of the present invention, said refreshable tactile display means 102 includes all suitable array geometries, and all suitable actuator technologies. In some embodiments, said refreshable tactile display means 102 can include a linear array of one or more rows of adjacent cells, or a tactile graphics display. In one embodiment, said refreshable tactile display means 102 can include a plurality of electromechanically actuated or controlled pins. In said embodiment disclosed of the present invention, said refreshable tactile display means 102 can include a plurality of fluid actuated or controlled elastic diaphragms, to enable tactile reading by said victim, where the fluid can include, but is not limited to, air. In particular, the use of the term “refreshable tactile display means” is not intended to be to limiting. For example, in U.S. Pat. No. 5,496,174, a refreshable tactile display device utilizes an electrorheological fluid to activate a plurality of tactile dots. The flow restriction produces a build-up of electrorheological fluid in a corresponding dot actuator chamber. The resulting pressure increase in the chamber displaces an elastic diaphragm fixed to a display surface to form a lump that can be perceived as one tactile dot. A flow regulation system provides a continually pressurized flow system and provides for free flow of the electrorheological fluid through the plurality of dot actuator chambers when they are not activated. In addition, a company that has implemented refreshable tactile display technology similar to U.S. Pat. No. 5,496,174 is BliTab (Blind Tablet), a company that makes a tablet targeted for blind or visually impaired persons.

In said embodiment disclosed of the present invention, said motion sensing means 206 includes a motion sensor, or a plurality of motion sensors that can measure the motion of said refreshable tactile communications means 100. Said plurality of motion sensors can include, but is not limited to, a rotational motion sensor, a linear motion sensor, and/or a Global Positioning System (GPS) means. In one embodiment of the present invention, said motion sensing means 206 can sense magnitude and direction of motion of said refreshable tactile communications means 100, for a continuous range of angles, and/or for a continuous range of directions, and/or for a continuous range of spatial displacements. In the present invention, said motion sensing means 206 senses motion that can include, but is not limited to, a linear motion, a change in linear motion, an angular motion, a change in angular motion, or any combination thereof. In said embodiment disclosed of the present invention, the focus will be on changes in angular motion.

One embodiment of said rotational motion sensor is a gyroscope, and one embodiment of said linear motion sensor is an accelerometer. In some embodiments of the present invention, from one to three gyroscopes can be provided, depending upon the motion to be sensed. Also, from one to three accelerometers can be provided, depending upon the motion that be sensed. Indeed, some embodiments of the present invention may employ more than three accelerometers and/or gyroscopes, to enhance accuracy, increase performance, and/or improve reliability. In this regard, 6-axis sensing, which provides sensing in all six degrees of freedom, can be achieved using 6 sensors, which these 6 sensors can include, but is not limited to, using three gyroscopes and three accelerometers. In embodiments with more than three gyroscopes and/or more than three accelerometers, additional degrees of freedom (or sensing axes) can be provided, and/or additional sensor input can be provided for each of the six axis of motion. In some embodiments, additional or alternate types of rotational rate sensors and/or linear acceleration sensors can be used.

Said motion sensing means 206 can also include other types of sensors, to provide additional sensor data about the environment in which said refreshable tactile communications means 100 is situated. For example, sensors such as one or more barometers, compasses or magnetometers, temperature sensors, optical sensors (such as a camera sensor, infrared sensor, ambient light sensor, etc.), ultrasonic sensors, radio frequency sensors, proximity sensors, chemical odor sensors (such as a carbon monoxide sensor), radiation sensors, electromagnetic radiation sensors, bio-sensors, pulse monitoring sensors, or other types of sensors can be provided. For example, a compass or magnetometer sensor can provide an additional one, two, or three axes of sensing.

It will be understood that said motion sensing means 206 may be embodied as a single sensor or a plurality of interconnected sensor sub-components, and be implemented in hardware, software, firmware or any combination thereof. For example, said motion sensing means 206 of said refreshable tactile communications means 100 may be embodied by an accelerometer or a plurality of accelerometers, a gyroscope or a plurality of gyroscopes, a compass or a plurality of compasses, a barometer or a plurality of barometers, or any combinations thereof, or by any other sensing resource or any combination of such sensing resources configured to operate collectively as a motion sensing means 206. In particular, the use of the term “motion sensing means” is not intended to be to limiting.

Said motion sensing means 206 generates an electrical signal, or a plurality of electrical signals, representative of the motion of said refreshable tactile communications means 100. In said embodiment disclosed of the present invention, said motion sensing means 206 is coupled to said processing means 208, and said electrical signal, or said plurality of electrical signals, is used by said processing means 208, to position and otherwise control a location, in said memory means 208 of said refreshable tactile communications means 100. When said victim moves said refreshable tactile communications means 100, said victim effects a corresponding movement of the location within said memory means 208.

As used herein, the term “processing means” 208 refers to an entity of said refreshable tactile communications means 100 that controls or executes, at least partially, the functions required for operating said refreshable tactile communications means 100. These functions can include, without being limited to, receiving from said motion sensing means 206 an electrical signal representative of the motion of said refreshable tactile communications means 100, translating said electrical signal into control signals that identify a location in said memory means 208, receiving from said memory means 208 an electrical signal representative of data 210 stored at said location, moving selectively individual tactile dots in a predetermined manner so as to display on said refreshable tactile display means 102 the data 210 stored at said location, managing communications using said transceiver means 216, processing commands, processing motion-based gestures, processing motion, managing power usage, performing language translations, converting voice audio from incoming phone calls into bone-conduction audio, managing a plurality of cameras and/or microphones, and performing video stabilization.

It will be understood that said processing means 208 may be embodied as a single means or a plurality of interconnected processing sub-components, and be implemented in hardware, software, firmware or any combination thereof. For example, said processing means 208 of said refreshable tactile communications means 100 may be embodied by a microprocessing means, a microcontroller, a central processing unit (CPU), a processing core, a system on a chip (SoC), a motion processing sub-component, a digital signal processing sub-component (DSP), a cryptoprocessing sub-component, a programmable logic device, or by any other processing resource or any combination of such processing resources configured to operate collectively as said processing means 208. In particular, the use of the term “processing means” 208 is not intended to be to limiting.

Said motion processing sub-component can include logic, microprocessors, controllers, and/or a sensor interface, to provide processing of motion sensor data in hardware. For example, motion algorithms, or parts of algorithms, may be implemented by said motion processing sub-component in some embodiments, for motion processing, for recognition of motion gestures, and for video stabilization of the output from said camera means 204. Some embodiments can provide a sensor fusion algorithm that is implemented by said motion processing sub-component to process all the axes of motion of provided sensors to determine the movement in space, of said refreshable tactile communications means 100. One of a plurality of examples of said sensor fusion algorithm is provided by InvenSense company. Said motion processing sub-component may include, but is not limited to, a gesture recognition engine. In one embodiment, said gesture recognition engine may include look-up tables filled with information relevant to particular gestures, and analyzes signals received from said motion sensing means 206 to determine when and which gestures have occurred. Said sensor interface translates said electrical signals, received from said motion sensing means 206, into location control signals, which identifies a location within said memory means 208.

It will be understood that said processing means 208 may be configured to transmit as the output data, the data 210 stored in said memory means 208 or communicated via said transceiver means 216, to said refreshable tactile display means 102. In particular, in some embodiments, there may be a one-to-one correspondence between data 210 stored in said memory means 208 or communicated via said transceiver means 216, and the output data displayed by said refreshable tactile display means 102. However, in other embodiments, there need not be such a one-to-one correspondence between data 210 stored in said memory means 208 or communicated via said transceiver means 216, and the output tactile data. The output tactile data displayed on said refreshable tactile display means 102 may originate not only from data 210 stored in said memory means 208 but also, or alternatively, from tactile content originating from other sources via said transceiver means 216. Exemplary other sources can include, without being limited to, a peripheral device wired or wirelessly coupled to said refreshable tactile communications means 100, such as said camera means 204 coupled to said refreshable tactile communications means 100. In an embodiment of the present invention, wherein said refreshable tactile communications means 100 includes said transducer means 220, said processing means 208 may also convert incoming voice audio to bone-conduction audio, which said processing means 208 sends to said transducer means 220. In some embodiments, said processing means 208 may include a conversion means to convert language coded information from one language to another language.

In said embodiment disclosed of the present invention, said processor means 212 receives from said motion sensing means 206 an electrical signal representative of the motion of said refreshable tactile communications means 100, translates said electrical signal into control signals that identify a location within said memory means 208, receives from said memory means 208 an electrical signal representative of data 210 stored at said location, and moves selectively individual tactile dots in a predetermined manner so as to display on said refreshable tactile display means 102 the data 210 stored at said location.

Said embodiment disclosed of the present invention can further include a payments means, for making wireless payments, similar to a credit/debit card. Said payments means is beneficial, when a victim has to escape quickly from a perpetrator leaving behind their belongings, because said payments means enables said victim to pay for essentials, which can include, but is not limited to, food, clothing, shelter, and transportation. In one embodiment, said payments means communicates with a card reader through an induction technology similar to RFID, using communication standards which can include, but is not limited to, ISO/IEC 14443, and/or ISO/IEC 15693. In said embodiment disclosed of the present invention, said payments means requires no battery, but instead, uses resonant inductive coupling, to capture some of the incident electromagnetic signal from said card reader, rectify it, and use it to power itself.

Said embodiment disclosed of the present invention can further include a tracker means, to enable said victim to more easily find said refreshable tactile communications means 100, when said refreshable tactile communications means 100 is made of a transparent, or semi-transparent material, and has been dropped, misplaced, or lost. Said tracker means can include encryption of tracker signal, so that a perpetrator cannot find, and remove the present invention, from said victim.

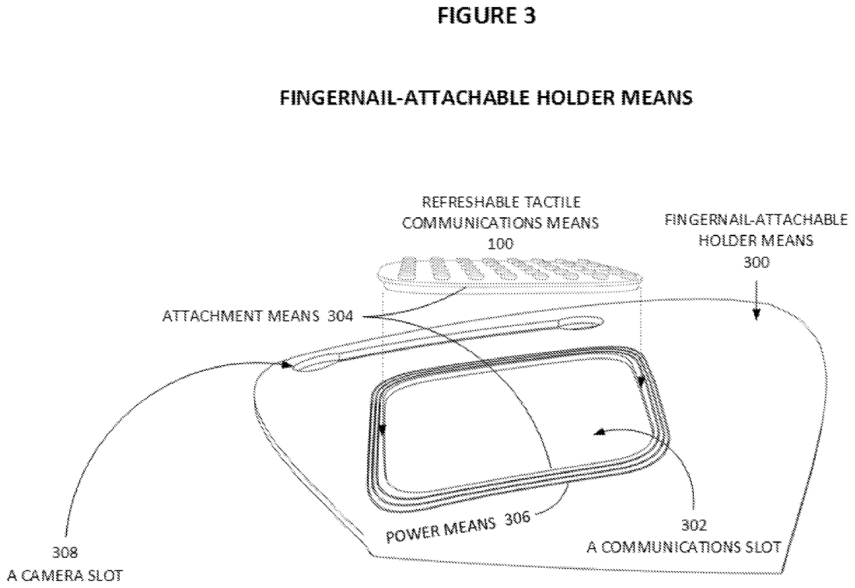

FIG. 3 illustrates one of a plurality of possible embodiments of said fingernail-attachable holder means 300. Said fingernail-attachable holder means 300 defines generally the overall shape of said embodiment disclosed of the present invention, and holds, supports and/or protects said refreshable tactile communications means 100 and said camera means. It will be appreciated that said fingernail-attachable holder means 300 may have an ergonomic shape, and be made of materials, that facilitate concealment, comfort, power generation, coupling of said means, and/or adhesion. It will also be understood that said fingernail-attachable holder means 300 may assume a variety of shapes other than a fingernail shape, where said variety of shapes can include, but is not limited to, rectangular, circular, semi-circular, square, elliptical, oval, parallelepipedal or trapezoidal. In said embodiment disclosed of the present invention, said fingernail-attachable holder means 300 will consist of a thin fingernail-shaped shell, made of a lightweight yet bendable material, such as, for example, a molded plastic shell. Since the size and shape of each fingernail, on a hand, can vary, said victim can choose to maintain a plurality of said thin fingernail-shaped shells, in order to change, on occasion, which fingernail contains said embodiment disclosed of the present invention, if desired.

In said embodiment disclosed of the present invention, said fingernail-attachable holder means 300 includes a communications slot 302. Said refreshable tactile communications means 100 can be removeably inserted into said communications slot 302, and secured to said fingernail-attachable holder means 300 using an attachment means 304. Being removeably inserted enables said victim to move from one of said plurality of said thin fingernail-shaped shells to another, a single said refreshable tactile communications means 100, when desired. Also, said attachment means 304 can include, but is not limited to, an adhesive attachment means, a mechanical attachment means, a magnetic attachment means, a molecular attachment means, and a chemical attachment means.

In said embodiment disclosed of the present invention, said fingernail-attachable holder means 300 will include at least one embodiment of power means 230, illustrated as a power means 306. Because said fingernail-attachable holder means 300 is coupled to said refreshable tactile communications means 100 and said camera means, said power means 306 shares the power it generates with said refreshable tactile communications means 100 and/or said camera means. Said power means 306 can include, but it not limited to, a battery, electromagnetic induction, and/or power harvesting. Power harvesting is the process by which energy is derived from external sources, captured, and stored for use by said means. These external sources include, but is not limited to, solar power, thermal energy, wind energy, salinity gradients, and kinetic energy, also known as ambient energy. One of a plurality of possible examples of kinetic energy harvesting is a piezoelectric generator, which generates energy when a material containing piezoelectric crystals or fibers is deformed. In one embodiment, a bendable piezoelastic material is used to make said fingernail-attachable holder means 300, thus enabling said fingernail-attachable holder means 300 to be used as a piezoelectric power generator/power means.

Said power harvesting also includes harvesting energy from incident radiation (e.g., a radio frequency antenna for inductively harvesting energy from incident radio frequency radiation and/or a photovoltaic cell for harvesting energy from incident visible, infrared, and/or ultraviolet light). In one of many possible embodiments, said power means 306 can include an induction coil, used to transfer power among the means. Said induction coil can be made of a transparent material as well, such as, for example, indium tin oxide, which is one of the most widely used transparent conducting oxides because of its two main properties: its electrical conductivity and optical transparency, as well as the ease with which it can be deposited as a thin film. Similarly, said battery can be made of a transparent material as well.

In said embodiment disclosed of the present invention, said fingernail-attachable holder means 300 includes a camera slot 308, used to secure said camera means to said fingernail-attachable holder means 300. Furthermore, said camera slot 308 enables said victim to extend said camera means beyond the fingertip, and then retract said camera means, when desired. Extending said camera means beyond the fingertip enables enhanced visibility of the surroundings of said victim, by said camera means.

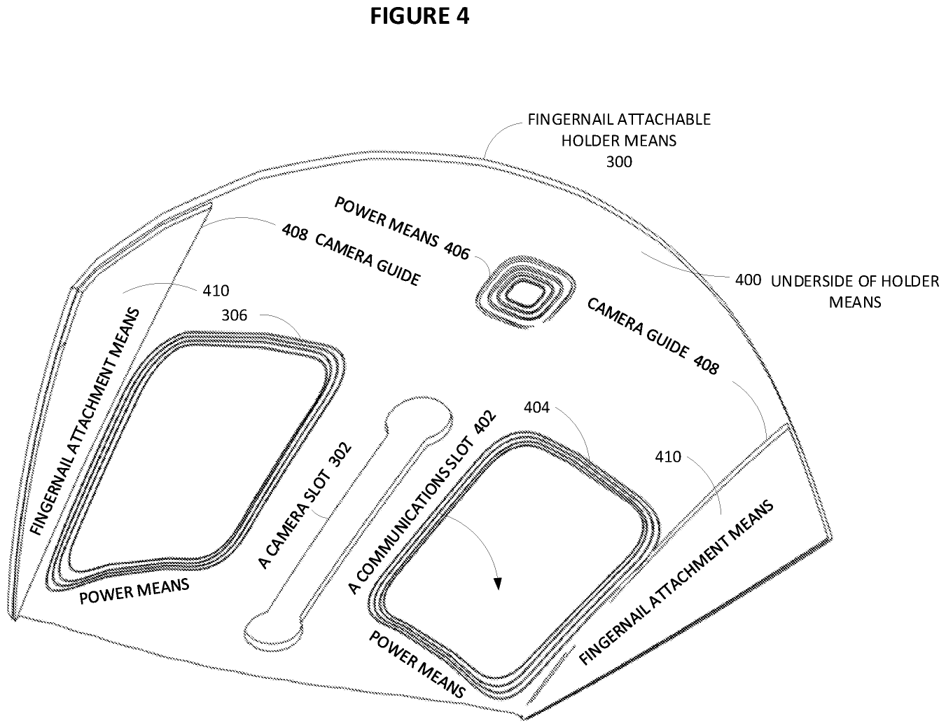

FIG. 4 illustrates the underside 400 of said fingernail-attachable holder means 300. In another embodiment of the present invention, a second communication slot 402 can be included in said fingernail-attachable holder means 300. Said second communication slot 402 can support a second communications means, where said second communications means can include, but is not limited to, a second refreshable tactile communications means, or a video communications means, where said video communications means includes a video display means, or a vibration communications means, where said vibration communications means can include, but is not limited to, a transducer, or a neural communication means, where said neural interface means enables said victim to communication using the brainwaves of said victim, and can include, but is not limited to, a neural sensor means and/or a neural stimulator means (refer to U.S. Pat. No. 9,857,590 B2). Said second communications means can be coupled to any combination of the other means. In another embodiment of the present invention, said fingernail-attachable holder means 300 can include a plurality of embodiments of power means 230, illustrated as a power means 404 and/or a power means 406. For example, said second communications means can be coupled to said power means 404. In said embodiment disclosed of the present invention, said fingernail-attachable holder means 300 includes said power means 406, where said power means 406 shares power with said camera means.

In said embodiment disclosed of the present invention, said fingernail-attachable holder means 300 includes a camera guide 408, where said camera guide 408 guides said camera means, as said camera means is being extended and retracted. In one embodiment, said fingernail-attachable holder means 300 and said camera guide 408 are manufactured together, as a single entity, and the fingernail-facing surface 410 of said camera guide 408 is secured to said fingernail using a fingernail attachment means, where said fingernail attachment means can include, but is not limited to, an adhesive attachment means.

In another embodiment, said fingernail-attachable holder means 300 and said camera guide 408 is manufactured as separate detachable entities. Said camera guide 408 can be manufactured as a transparent magnet, and the portion of said fingernail-attachable holder means 300, which makes contact with the holder-facing surface, located on the opposite side of the fingernail-facing surface 410, can also be manufactured as a transparent magnet. This enables said fingernail-facing surface 410 of said camera guide 408 to be secured to said fingernail using said fingernail attachment means, while enabling said fingernail-attachable holder means 300 be easily attached and detached from said fingernail, using magnetic coupling. See Ziolo, Ronald, “See-Through Magnets—Value of the First Step”, R&D Innovator Volume 3, Number 11 (November 1994); and Pennisi, Elizabeth, “Nanotechnology yields transparent magnet—tiny iron oxide particles become more transparent than in bulk form”, Sciences Services Group (1992).

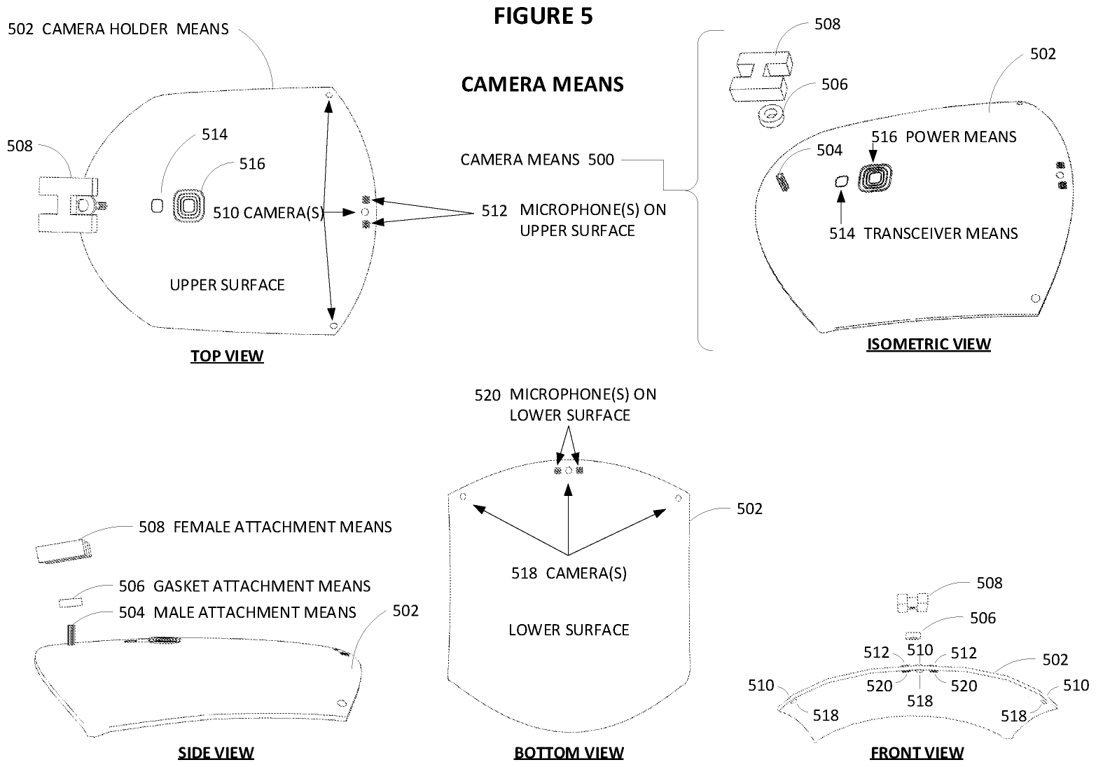

FIG. 5 illustrates one of a plurality of possible embodiments of said camera means 500, which can include, but is not limited to:
a camera holder means, illustrated as 502;
at least one camera, illustrated as 510 and 518, which is one embodiment of camera(s) 232;
at least one microphone, illustrated as 512 and 520, which is embodiment of microphone(s) 234;
a transceiver means, illustrated as 514, which is one embodiment of transceiver means 236;
a power means, illustrated as 516, which is one embodiment of power means 238;
an attachment means, illustrated as 504, 506, and 508.

Said camera holder means 502 defines generally the overall shape of said camera means 500, and holds, supports and/or protects cameras 510 and 518, microphones 512 and 520, said transceiver means 514, said power means 516, and said attachment means 504, 506, and 508. Said camera means 500 is made of at least one material that is transparent, semi-transparent, or easily concealable because of its size, shape, or color. It will be appreciated that said camera means 500 may have an ergonomic shape, and be made of materials, that facilitate concealment, comfort, power generation, coupling of said means, and/or adhesion. It will also be understood that said camera holder means 502 may assume a variety of shapes other than a fingernail shape, which can include, but is not limited to, rectangular, circular, semi-circular, square, elliptical, oval, parallelepipedal or trapezoidal.

In said embodiment disclosed of the present invention, said camera holder means 502 will consist of a thin shell, (in whole or in part) fingernail-shaped, made of lightweight yet bendable material such as, for example, a molded plastic shell. In one embodiment, the bendable material is made of a bendable piezoelastic material that enables said camera holder means 502 to be used as a piezoelectric power generator/power means. Also, in said embodiment disclosed of the present invention, said camera means 500 will be encapsulated (in whole or in part), to protect said camera means 500 from the liquids, gases, and solids, that the hands might encounter.

In said embodiment disclosed of the present invention, only one of a plurality of possible attachment means is illustrated, in FIG. 5, as an example. Said camera means 500 is secured to said fingernail-attachable holder means 300, using an attachment means, where said attachment means includes a male attachment means 504 integrated with said camera holder means 502, a gasket attachment means 506, and a female attachment means 508, as illustrated in the side view of FIG. 5. In one of a plurality of possible embodiments of said female attachment means 508, said female attachment means 508 can also function as a power generator/power means, which can include, but is not limited to, kinetic energy harvesting, where said female attachment means 508 includes a wire coil and magnets that slide across said wire coil, to generate power. Also, both said magnets and said wire coil can be made of a transparent material, to enhance concealment.

In said embodiment disclosed of the present invention, the upper surface of said camera holder means 502 includes at least one camera 510 and at least one microphone 512, as illustrated in the top view and front view of FIG. 5. The upper surface of said camera holder means 502 includes said transceiver means 514, where the uses of said transceiver means 514 can include, but is not limited to, live streaming of audio video data from the camera(s) 510 and/or 518 and microphone(s) 512 and/or 520 included with said camera means 500. In one of a plurality of possible embodiments, said camera means 500 can be configured to transmit, using said transceiver means 514, live streaming audio video data directly to said refreshable tactile communications means 100. In another embodiment, said camera means 500 can be configured to transmit, using said transceiver means 514, live streaming audio video data directly to Internet-accessible storage, out of reach of said perpetrator. In yet another embodiment, said camera means 500 can be configured to transmit, using said transceiver means 514, live streaming audio video data directly to the smartphone of said victim. In still one more embodiment, said camera means 500 can be configured to transmit, using said transceiver means 514, live streaming audio video data directly to said refreshable tactile communications means 100, and then said refreshable tactile communications means 100 transmits the data to Internet-accessible storage.

In said embodiment disclosed of the present invention, said camera means 500 will include said power means 516. Said power means 516 can include, but it not limited to, a battery, electromagnetic induction, and/or power harvesting. In one of many possible embodiments, said power means 516 can include an induction coil, used to transfer power among the means. In said embodiment disclosed of the present invention, said fingernail-attachable holder means 300 includes said camera slot 308, used to secure said camera means 500 to said fingernail-attachable holder means 300. In said embodiment disclosed of the present invention, the lower surface of said camera holder means 502 includes at least one camera 518 and at least one microphone 520, as illustrated in the bottom view of FIG. 5.

In said embodiment disclosed of the present invention, said camera means 500 is coupled, via said camera slot 308 and attachment means 504, 506, and 508, to said fingernail-attachable holder means 300. By sliding said female attachment means 508 along said camera slot 308, camera(s) 510 and 518 can be extended beyond the fingertip, and retracted. Extending the camera(s) beyond the fingertip enhances the situational awareness of said victim, thus providing and recording a more complete picture of the surroundings of said victim. The cameras 510 and/or 518 can include, but is not limited to, at least one daytime camera (for daylight), and at least one nighttime camera (for nightlight). A thermal imaging camera is one of a plurality of possible examples of a nighttime camera. Said thermal imaging camera is an excellent tool for night vision, because they detect thermal radiation and do not need a source of illumination, they can produce an image in the darkest of nights and can see through light fog, rain and smoke (to a certain extent), and they can make small temperature differences visible.

In other embodiments of the present invention, said camera means 500 can be extended beyond the fingertip, to capture images of documents in possession of said perpetrator. If desired by said victim, Optical Character Recognition (OCR) can be performed by said processor means 212 on the document images captured, and the textual output of this OCR process displayed on said refreshable tactile display means 102, for tactile reading by said victim, or for bone conduction audio, using a text-to-speech (TTS) software on said processor means 212. In said embodiment disclosed of the present invention, audio video data, output by said camera means 500 is transmitted automatically to said refreshable tactile communication means 100, using said transceiver means 514 coupled with said camera holder means 502.

In said embodiment disclosed of the present invention, the act of extending said camera means instructs said refreshable tactile communications means 100 to start transmitting live audio video data, received from said camera means 500, directly to Internet-accessible storage, where said refreshable tactile communications means 100 uses its phone-capable transceiver means 216 to communicate directly with the Internet, using the phone network. The evidence collected is stored remotely, out of reach of said perpetrator. Examples of vendors of Internet-accessible storage include Dropbox, Box, Google Drive, and OneDrive by Microsoft.

In one embodiment of the present invention, said victim can create, in advance, a list of persons allowed to access the evidence collected, and who will be notified, automatically, when evidence is deposited into Internet-accessible storage. Each such person is referred to herein as a designated recipient. Said designated recipient can include, but is not limited to, a family member, a friend, a lawyer, a reporter, a coworker, a police department, and/or a public website (e.g. YouTube). In said embodiment disclosed of the present invention, said designated recipient can review the evidence collected, and provide realtime feedback to said victim. This feedback can include, but is not limited to, a text message, a phone call, and/or a money transfer to said payments means 224.

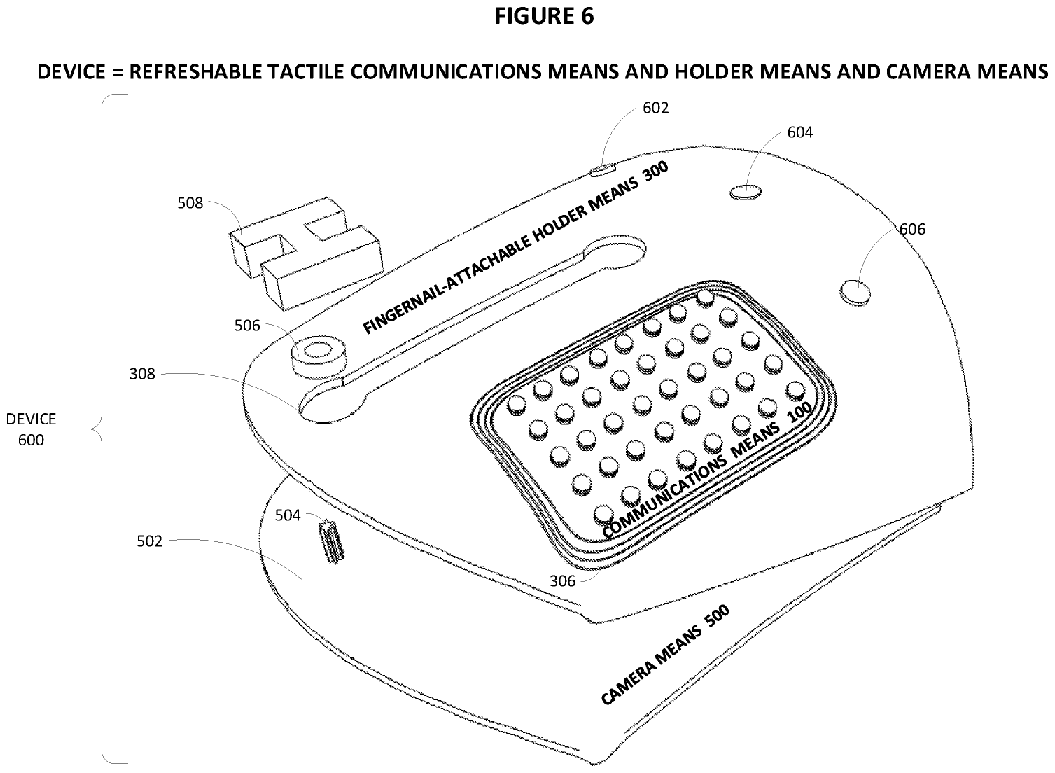

FIG. 6 illustrates an assembly diagram for said embodiment disclosed of the present invention, referenced as a device 600. The male attachment means 504, integrated with said camera means 500, is inserted through said camera slot 308 of said fingernail-attachable holder means 300. Said gasket attachment means 506, made of at least one of a plurality of possible expandable/compressible materials, such as an elastomer, for example, is place over said male attachment means 504. Said male attachment means 504 is then inserted into said female attachment means 508, to secure said camera means 500 to said fingernail-attachable holder means 300. As said victim slides said female attachment means 508 along said camera slot 308, said gasket attachment means 506 contracts between the endpoints of said camera slot 308, and then expands at each endpoint of said camera slot 308. One endpoint of said camera slot 308 corresponds to said camera means 500 being fully retracted, and the other endpoint of said camera slot 308 corresponds to said camera means 500 being fully extended (i.e. cameras extend beyond the fingertip).

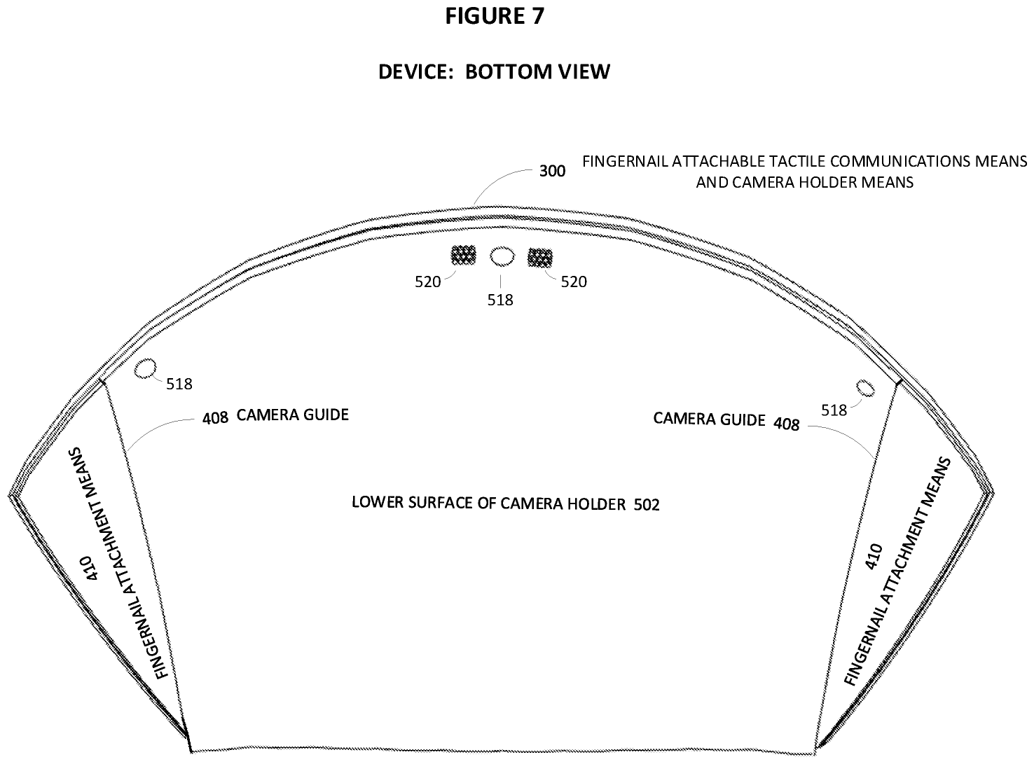

Said embodiment disclosed of the present invention can further include at least one button means, as illustrated in 602, 604, and 606. FIG. 7 illustrates the bottom view of said device 600. As illustrated in FIG. 7, it will be appreciated that said camera holder means 502, and said camera guide 408, may each have an ergonomic shape, and be made of materials, that facilitate the extending and retracting of said camera holder means 502, guided by said camera guide 408.

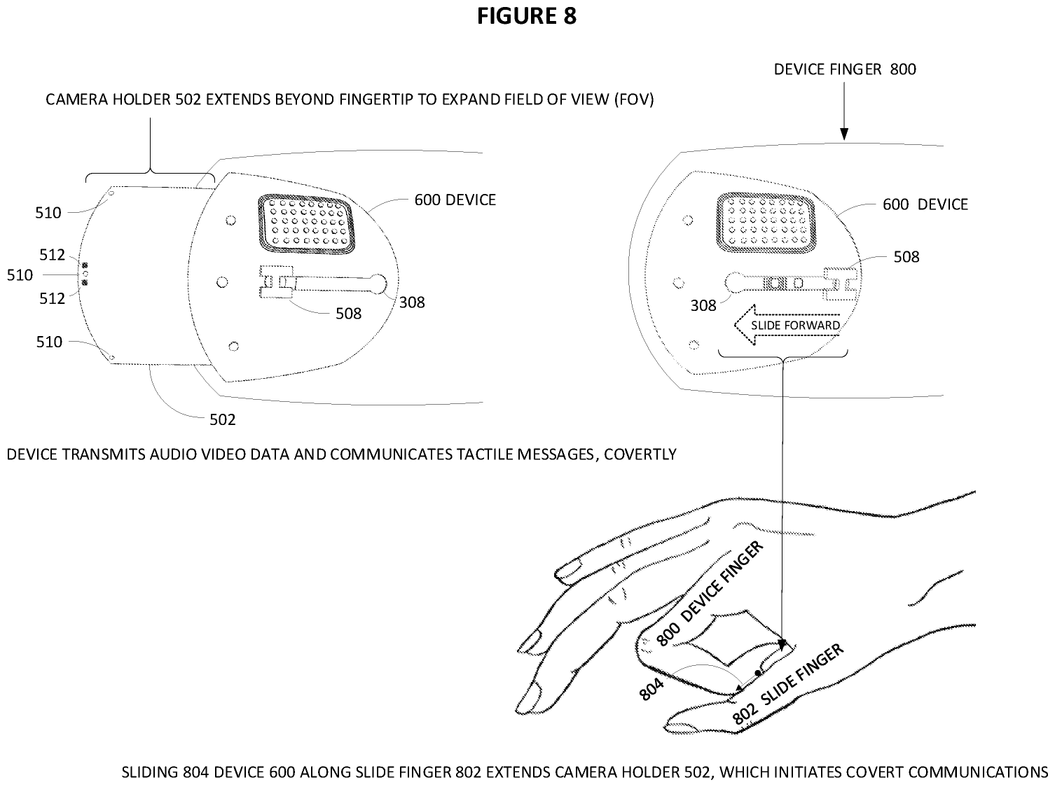

As illustrated in FIG. 8, and as used herein, a device finger 800 means the finger that contains the fingernail upon which said device 600 is attached. A slide finger 802 means the finger used, by said victim, to slide said female attachment means 508 along said camera slot 308, in order to extend or retract said camera holder means 502. In said embodiment disclosed of the present invention, when said victim fully extends said camera holder means 502, live streaming of audio video data is initiated. In one embodiment of a plurality of possible embodiments, live streaming of audio video data from said camera means 500 is transmitted to said refreshable tactile communications means 100, where said refreshable tactile communications means 100 may augment the audio video data received with additional data, and transmits this augmented data to Internet-accessible storage, out of reach of said perpetrator.

In one of a plurality of possible embodiments, the method by which live streaming of audio video data is “initiated” can be due to sensor, such as Hall Effect sensor, included with said device 600, which can detect when said power means 406 and said power means 516 are aligned above/below each other. Said Hall effect sensor is a transducer that varies its output voltage in response to a magnetic field. Hall effect sensors are used for proximity switching, positioning, speed detection, and current sensing applications. When fully extended, power means 406 aligns with power means 516, and creates inductive coupling. Hall Effect sensors, included with said power means 406 and/or 516, and coupled to refreshable tactile communications means 100, detect this inductive coupling, and signal said refreshable tactile communications means 100 to initiate live streaming of audio video being received from said camera means 500. Thus, said embodiment disclosed of the present invention enables said victim to initiate, covertly, live audio video streaming, and tactile communications, by simply sliding 804 said device finger 800 along said slide finger 802. When fully extended beyond the fingertip, the camera(s) 518, located on the lower surface of said holder means 502, can enable recording live video of events happening “behind” said victim, such as when the hands of said victim are at the side of said victim.

In said embodiment disclosed of the present invention, said victim configures said refreshable tactile communications means 100 to stream, automatically, live audio/video data from said camera means 500 to Internet-accessible storage, to family, and/or to friends, when said camera is turned ON. Streaming live audio video data to Internet-accessible storage removes evidence from close proximity of said perpetrator, who would be prone to destroy such evidence. The audio video data being deposited into Internet-accessible storage can be streamed automatically to family and/or friends as well, thus providing live situational awareness of said victim, to family and/or friends, while said victimization is in progress. In said embodiment disclosed of the present invention, family and/or friends can communicate covertly with said victim, while said victimization is in progress.

Covert communications between family and/or friends, and said victim, can include, but is not limited to, textual messages. In said embodiment disclosed of the present invention, at least one symbol set is stored in said memory means 208, where a symbol set is used for coding characters into tactile symbols, where characters include, but is not limited to, letters of the alphabet, and the tactile symbols are used when displaying textual messages on said refreshable tactile display means 102. The development of symbol sets used for coding characters into tactile symbols can be classified as follows:
(1) Codes in which the tactile symbols are exact or modified copies of their visual counterparts. Embossed letters and Moon type are examples of this type of code. These codes have been developed for persons who are not visually impaired.
(2) Codes in which the tactile symbols bear little or no relation to the standard printed alphabetic shapes. Braille is an example of this type of code. These codes have been developed for persons who are blind or visually impaired.

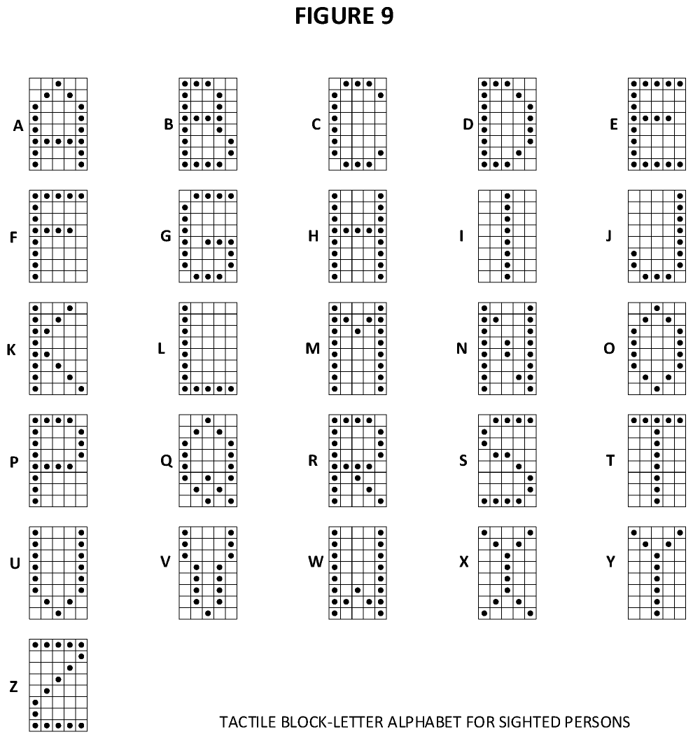

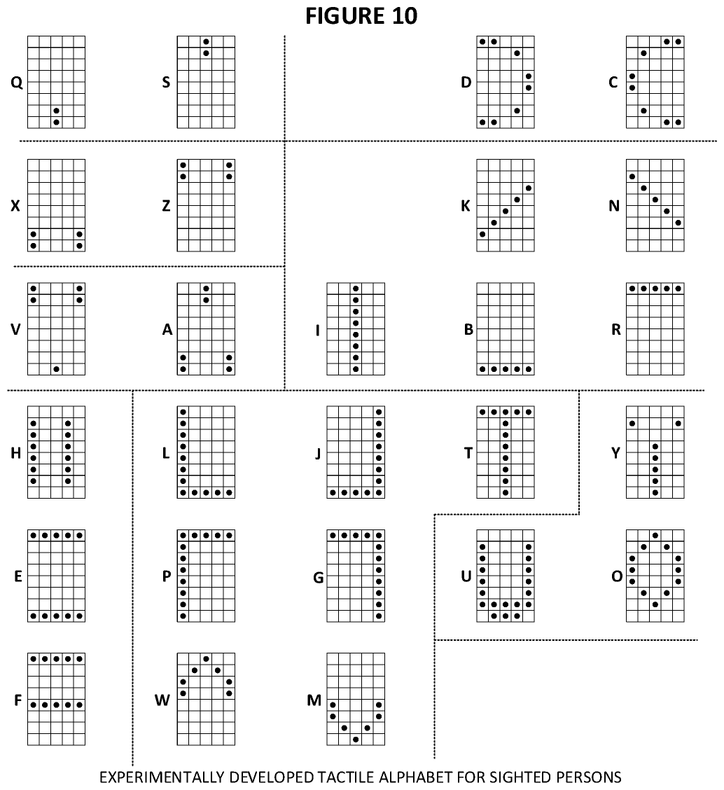

In said embodiment disclosed of the present invention, both classifications of codes discussed above are supported, and said processor means 212 can translate, automatically, between symbol sets and/or between languages. FIG. 9 illustrates one of a plurality of possible examples of symbol sets, for the first classification of codes discussed above, displayable on said refreshable tactile display means 102, for persons who are not visually impaired. As another of said plurality of possible examples of symbol sets, for the first classification of codes discussed above, displayable on said refreshable tactile display means 102, FIG. 10 illustrates an experimentally developed symbol set used for coding characters into tactile symbols, where the purpose of the experiments was to increase both the accuracy and speed of tactile recognition of characters, by persons who are not visually impaired. A comprehensive discussion of tactile recognition, including FIG. 9 and FIG. 10, is contained in the following reference: See Bliss, James C. and Hewitt, Crane D., “Experiments in Tactual Perception”, Stanford Research Institute (SRI) Final Report for NASA Contract NAS 2-1679 (January 1965).

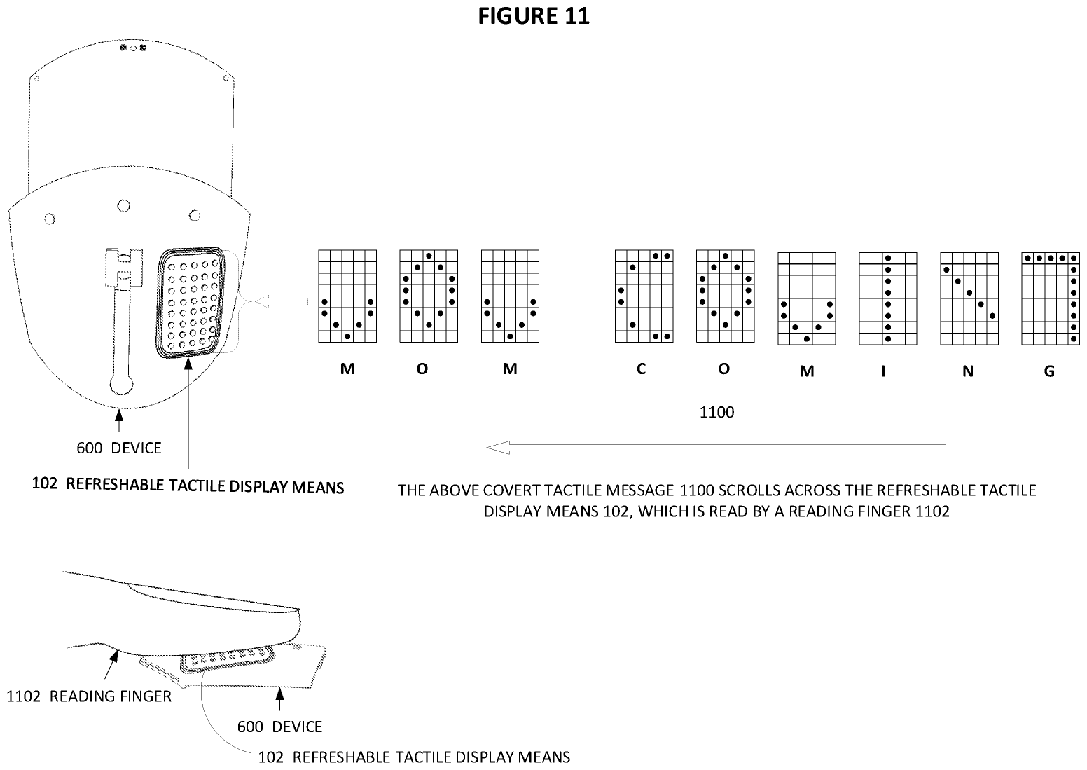

FIG. 11 illustrates an example of a covert textual message “mom coming” 1100 sent from a family member, to said victim. Said processor means 212 translates the incoming said covert textual message “mom coming” 1100 into the experimentally developed symbol set illustrated in FIG. 10, and scrolls said covert textual message “mom coming” 1100 across said refreshable tactile display means 102 in a manner similar to an electronic stock market ticker tape display. In said embodiment disclosed of the present invention, when a textual message is scrolled across said refreshable tactile display means 102, a character pattern (such as “m” of “mom”) is introduced on one edge of said refreshable tactile display means 102, and said character pattern continues to move across said refreshable tactile display means 102, one column at a time, until the said character pattern (such as “m” of “mom”) runs off the other edge of said refreshable tactile display means 102, and similarly for the other character patterns contained within “mom coming” 1100. Thus, scrolling is essentially a series of presentations of the character pattern, with said character pattern shifted from one column to the next column, until said character pattern runs off the other edge of said refreshable tactile display means 102, and similarly for the other character patterns contained within said covert textual message.

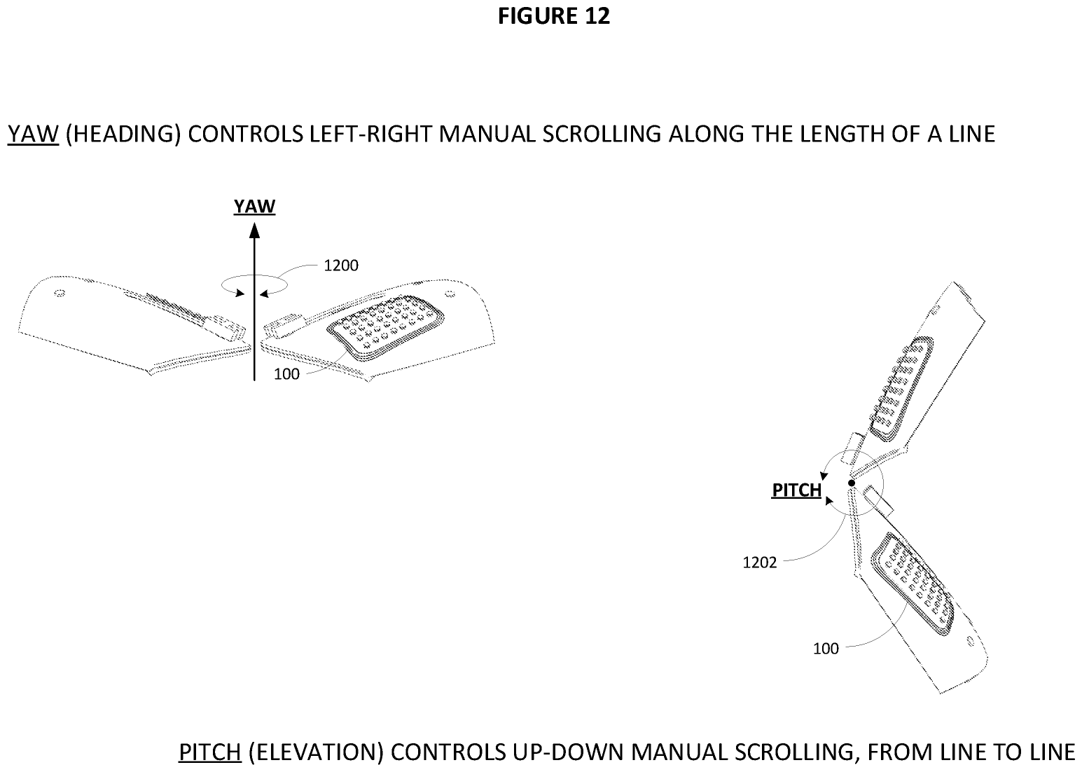

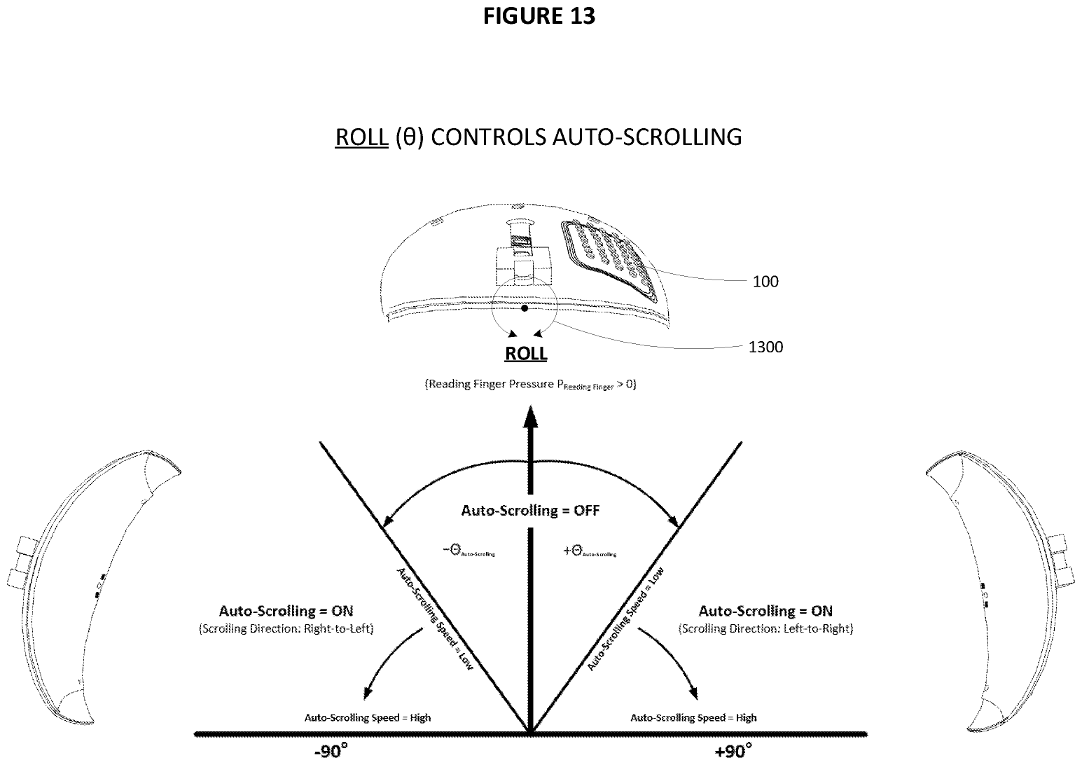

In order to read, covertly, said covert textual message “mom coming” 1100, said victim places a fingertip in contact with said refreshable tactile display means 102, in order to “feel” the character patterns scrolling across said refreshable tactile display means 102. The finger, containing the fingertip used for tactile reading, is referred to herein as a reading finger 1102, as illustrated in FIG. 11. Said reading finger 1102 can be located on the same hand as said device finger 800, or said reading finger 1102 can be located on a different hand than said device finger 800. In said embodiment disclosed of the present invention, said reading finger 1102 can also be used to operate said device 600. Operating said device 600 can include, but is not limited to, clicking optional said button means 114 and/or 602 and/or 604 and/or 606. In order to create, or select, an outgoing covert textual message to transmit, said victim can accomplish this in a plurality of possible ways, which can include, but is not limited to, navigating said memory means 208 to locate, and then select, the desired individual characters needed to create the message, or navigating said memory means 208 to locate, and then select, at least one word, phrase, or sentence, contained within at least one text template, needed to create the message. In said embodiment disclosed of the present invention, FIG. 12 and FIG. 13 illustrate one of a plurality of possible ways said victim can navigate said memory means 208.

In FIG. 12 and FIG. 13, said victim navigates said memory means 208 using motion-based gestures, enabled by said motion sensing means 206, where said motion sensing means 206 is coupled to said memory means 208. In said embodiment disclosed of the present invention, the motion-based gestures used will include, but is not limited to, Yaw, Pitch, and Roll. These three motion-based gestures can be understood intuitively with reference to an airplane. For example, Yaw describes the left-right motion of said airplane (i.e. its “Heading”). Pitch describes the up-down motion of said airplane (i.e. its “Elevation”), such as during take-off, or landing. Roll describes the rotation of the passenger cabin of said airplane, similar to twisting a straw between two fingertips. In said embodiment disclosed of the present invention, said refreshable tactile communications means 100 plays the role of said airplane, where Yaw, Pitch, and Roll describes changing the angular orientation of said refreshable tactile communications means 100. Thus, said victim navigates said memory means 208 of said refreshable tactile communications means 100, by changing the angular orientation of said refreshable tactile communications means 100.

In said embodiment disclosed of the present invention, said victim often will be navigating lines of text within said memory means 208, therefore, in said embodiment disclosed of the present invention, Yaw, Pitch, and Roll, will be expressed intuitively as follows:
1. Yaw→Controls “LEFT and RIGHT Scrolling” along a Line of Text
(FIG. 12, diagram 1200)
2. Pitch→Controls “UP and DOWN Scrolling” from Line to Line
(FIG. 12, diagram 1202)
3. Roll→Controls “Automatic Scrolling” of Text
(FIG. 13, diagram 1300)

Said victim can initiate, control the direction of, and control the speed of, automatic scrolling (i.e. auto-scrolling) as illustrated in the following example of FIG. 13:

If said victim sets the auto-scrolling angle to ϑ_{Auto-Scrolling}=30°, then:
auto-scrolling=OFF: when −30°<ϑ<+30°, when −180°≤ϑ<−90°,
or when +90°<ϑ≤+180°
auto-scrolling=ON: when −90°≤ϑ≤−30°, or when +30°≥ϑ≥+90°

Said victim sets the values for Auto-scrolling Speed=Low and Auto-scrolling Speed=High.

In said embodiment disclosed of the present invention, the Auto-scrolling Speed increases continuously from Auto-scrolling Speed=Low to Auto-scrolling Speed=High.

In said embodiment disclosed of the present invention, said victim can control the Scrolling Resolution, expressed as follows:
Scrolling Resolution=“Characters Scrolled” Per “One Degree Change in Angular Orientation”.

For example, if a typical text line contains 100 characters, and if said victim wants Yaw not to exceed 20° rotation, then:
Yaw Scrolling Resolution=5 Characters Scrolled/1° Yaw
(i.e. =100 Characters Scrolled/20° Yaw)

In a similarly manner, said victim can control Pitch Scrolling Resolution, and Roll Scrolling Resolution.

In another embodiment of the present invention, said victim uses a specified button on said device 600, to turn auto-scrolling ON or OFF. In still another embodiment, said victim uses jerk detection (i.e. a quick change in “roll” orientation) to turn auto-scrolling ON or OFF. In another embodiment, the speed and direction of auto-scrolling may be determined based on acceleration direction at jerk, the scrolling direction at jerk instant, or victim's preference. In one embodiment, said victim receives feedback regarding the changes in the orientation of said refreshable tactile communications means 100, when executed. One of a plurality of possible ways the feedback can be implemented is coupling a transducer means with said refreshable tactile communications means 100, to provide vibration-based feedback. In another embodiment, jerk detection (i.e. a quick change in “ROLL” orientation) can be used to make a “selection”, at the target location.

In said embodiment disclosed of the present invention, the amount by which the Scrolling Resolution is reduced, is determined by a Reduction Coefficient β, where the value of said Reduction Coefficient β is customizable by said victim. For example, if said victim chooses β= 1/20, then the reduction in the Yaw Scrolling Resolution is:
=β*(100 Characters Scrolled/20° Yaw)
= 1/20*(100 Characters Scrolled/20° Yaw)
=(5 Characters Scrolled/20° Yaw)

### (Yaw Scrolling Resolution)_{reduced}=(1 Character Scrolled/4° Yaw) or (¼ Character Scrolled/1° Yaw).

In a similar manner, said victim can customize the reduction in Pitch Scrolling Resolution, and Roll Scrolling Resolution, as well.

In one embodiment, the same β is applied to reduce Yaw, and to reduce Pitch, Scrolling Resolutions. In another embodiment, the same β is applied to reduce Yaw, to reduce Pitch, and to reduce Roll, Scrolling Resolutions. In still another embodiment, a different β is applied to reduce Yaw, and to reduce Pitch, Scrolling Resolutions. In yet another embodiment, a different β is applied to reduce Yaw, to reduce Pitch, and to reduce Roll, Scrolling Resolutions. Several patents and publications describe detection of movement in 3D and/or detection of movement in air, which include U.S. Pat. Nos. 5,543,758; 6,104,380; 5,554,980; and 5,363,120.

Using said reading finger 1102 to make a “selection” by pressing a button on said device 600, while said device 600 is in air, can present challenges, because controlling the orientation of said device 600 becomes difficult, due to the unintentional motion created when said reading finger 1102 applies a pressure P_{Reading Finger} to said device 600. To reduce the adverse effects of this unintentional motion, the Scrolling Resolution can be reduced, momentarily, to improve precision. In said embodiment disclosed of the present invention, the Scrolling Resolution is reduced when said reading finger 1102 applies a pressure P_{Reading Finger}≥P_{zoom}, where P_{zoom} is the pressure needed to turn ON the Zoom/Speed Reduction feature of said refreshable tactile communications means 100. In one embodiment, to turn OFF the Zoom/Speed Reduction feature, the pressure applied by said reading finger 1102 is simply reduced below P_{zoom}, i.e. P_{Reading Finger}<P_{zoom}. In one embodiment of the present invention, a “selection” is accomplished, by having said device 600 hover at a target location, in said memory means 208, for time T=T_{selection}, while zoom is turned ON. When the wait time T_{selection} is reached, said refreshable tactile communications means 100 performs the selection, automatically, of the data 210 or command at said target location, in said memory means 208. Said victim can choose to have said refreshable tactile communications means 100 automatically turn OFF the Zoom/Speed Reduction feature, after selection is made.

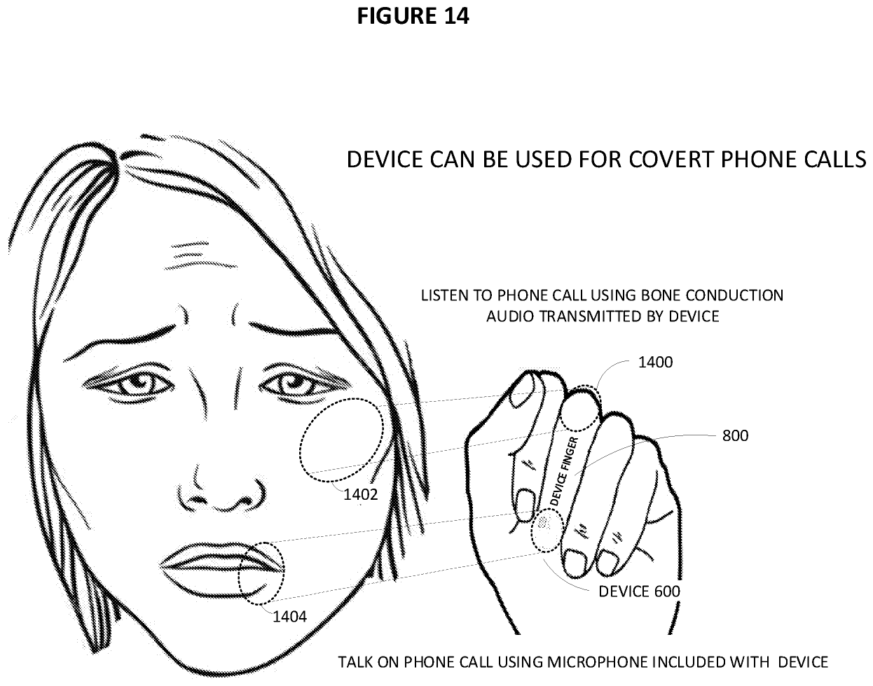

In said embodiment disclosed of the present invention, wherein said refreshable tactile communications means 100 further includes said transducer means 220, said device 600 can be used as a covert phone, as illustrated in FIG. 14. Said processor means 212, coupled to said transceiver means 216, receives an incoming audio signal from said transceiver means 216, and sends said incoming audio signal to said transducer means 220. Said transducer means 220, coupled to said processor means 212, receives said incoming audio signal from said processor means 212, and coverts said audio signal into vibrations representative of said audio signal, where the vibrations generated are transmitted through the bones and/or skin of said device finger 800, and where the bones can include, but is not limited to, a knuckle 1400 of said device finger 800.

In one of a plurality of possible examples, illustrated in FIG. 14, to listen to an incoming phone call, said victim places said knuckle 1400 to a bone on the head of said victim, where said bone on the head can include, but is not limited to, a cheekbone 1402. The vibrations generated by said device 600 are transmitted through said device finger 800, through said knuckle 1400, through said cheekbone 1402, and into the inner ear of said victim. By placing said device 600 near the mouth 1404, said victim can speak during said phone call, using at least one microphone 512 and/or 520 included with said camera means 500. When said victim is speaking, an outgoing audio signal is generated by at least one microphone 512 and/or 520, and transmitted to said caller using said transceiver means 216, where said transceiver means 216 connects to a cellular or satellite phone network. The present invention can further include said speaker 222, where said speaker 222 can be used as an alternative to bone conduction audio, on those occasions when said victim does not have to listen covertly. Furthermore, said transducer means 220 can also convert audio data stored in said memory means 208 to vibrations transmitted through the bones and/or skin of said device finger 800 as well.

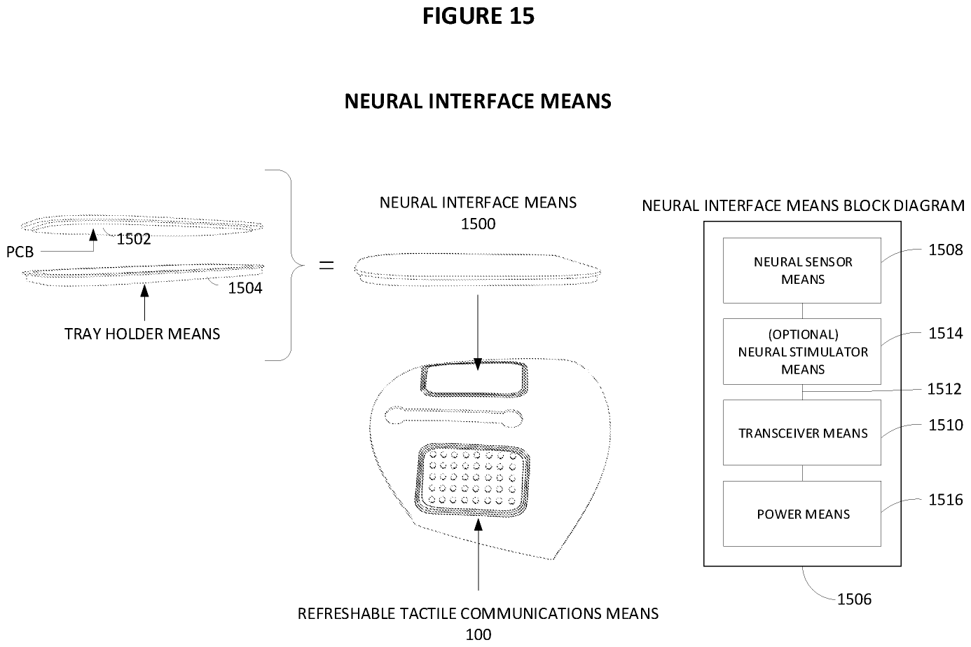

Said embodiment disclosed of the present invention can further include a neural interface means 1500, for said refreshable tactile communications means 100, as illustrated in FIG. 15. Said neural interface means 1500 is removably inserted into said communications slot 402, and gets power from said power means 404, and is coupled to said refreshable tactile communications means 100, and said fingernail-attachable holder means 300, and/or said camera means 500, or any combination thereof.

Said neural interface means 1500 has a PCB 1502, which fits inside a tray holder means 1504. A block diagram 1506 of said PCB 1502 can include, but is not limited to, the following:

A neural interface means, comprising:
a. a neural sensor means 1508 operative to generate one or more signals indicative of brainwave emissions;
b. a transceiver means 1510 having at least one input coupled to an output of said neural sensor means 1508, said transceiver means 1510 receiving, via at least one bus 1512, the one or more signals therefrom and transmitting the one or more signals to said refreshable tactile communications means 100 or other computing system, for processing;
c. a neural stimulator means 1514 operative to receive, from said transceiver means 1510, and then transmit to a brain, one or more signals indicative of brainwave emissions, said transceiver means 1510 having at least one output coupled to the input of said neural stimulator means 1514.
d. a power means 1516 operative to provide power to at least one means;

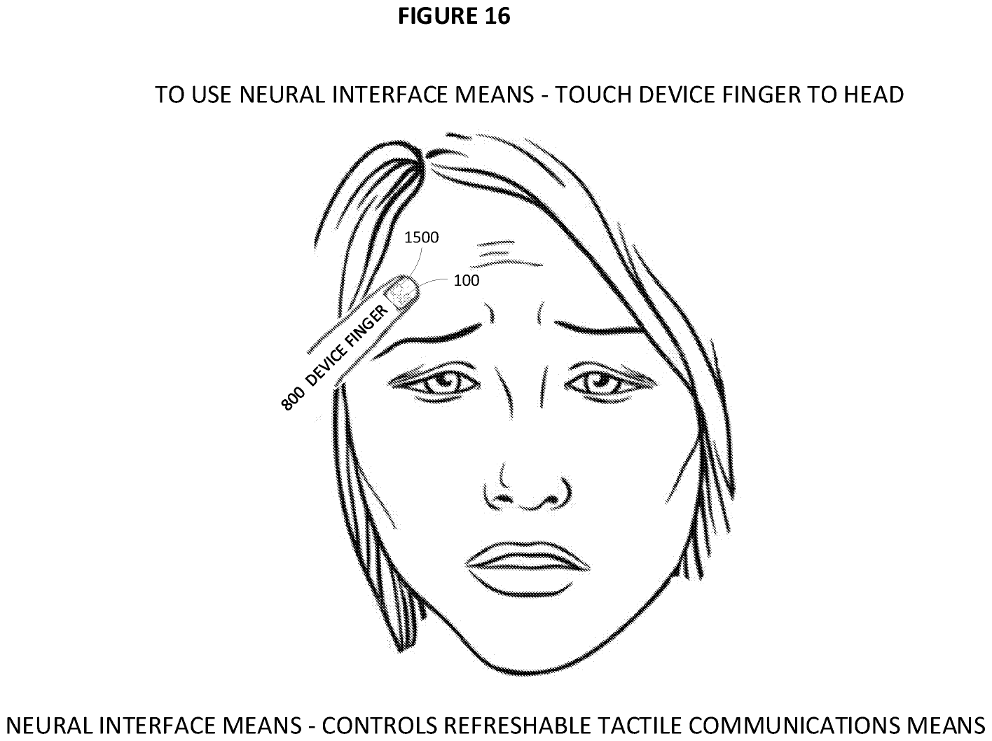

Said neural interface means 1500 enables said victim to control said refreshable tactile communications means 100 using the thoughts of said victim. This control can include, but is not limited to, issuing commands, and writing text messages, using the thoughts of said victim. Moreover, said neural interface means 1500 can enable the wireless digital sharing of the senses of said victim, where the senses can include the thoughts, smell, taste, touch, sight, and hearing that is being experienced by said victim. When said victim touches said device finger 800 to the skull, as illustrated in FIG. 16, said neural sensor means 1508 detects the brainwave emissions from said victim and, using said transceiver means 1510, transmits the brainwave emissions to said refreshable tactile communications means 100, for processing.

Said processor means 218 looks for patterns and spikes, referred to as Evoked Potentials, contained within said brainwave emissions received. These evoked potentials are then decoded, by said processor 218, into thoughts, smell, taste, touch, sight, and sounds. Each evoked potential, or set of evoked potentials, corresponds to specific thoughts, smells, tastes, touch, visual images, or sounds. Moreover, said evoked potentials typically appear in the 3 Hertz-50 Hertz frequency range, thus in one embodiment, said neural interface means 1500 will operate within a frequency range which includes said 3 Hertz-50 Hertz frequency range. In one embodiment of the present invention, to aid with this decoding, said processor means 218 uses published research data from a plurality of classifications, which can include, but is not limited to, ElectroEncephaloGram/ElectroEncephaloGraphy (EEG), muscle ElectroMyoGraphy (EMG), ElectroOculoGram (EOG), ElectroCadioGram (ECG/EKG), and others. See: Vidal, J J (1973), “Toward direct brain-computer communication”, Annual review of biophysics and bio engineering 2: 157-80, doi:10.1146/annurev.bb.02.060173.001105.PMID 4583653; J. Vidal (1977), “Real-Time Detection of Brain Events in EEG” IEEE Proceedings 65: 633-641, doi:10.1109/PROC. 1977.10542, http://www.cs.ucla.edu/˜vidal/Real JTime_Detection.pdf; and Lebedev, M A; Nicolelis, M A (2006), “Brain-machine interfaces: past, present and future.” Trends in neurosciences 29 (9): 536-46, doi: 10.1016/j.tins.2006.07.004.PMID 16859758.

Once the brainwave emissions are decoded, they can be expressed in textual format, and said refreshable tactile communications means 100 can provide confirmation feedback to said victim using not only tactile feedback, but alternatively using bone-conduction audio feedback. More specifically, said processor means 218 can convert the textual format into an audio signal, using Text-to-Speech (TTS) software, and send said audio signal to said transducer means 220, where said transducer means 220 generates and transmits to the inner ear of said victim, via device finger 800, vibrations representative of said audio signal. Software 244 can include, but is not limited to, said Text-to-Speech (TTS) software, and data 210 can include, but is not limited to, evoked potentials data.

Said neural stimulator means 1514 transmits information received to the brain of said victim, using brain stimulation, where brain stimulation triggers said evoked potentials (events) in the brain. These triggered events create thoughts, taste, touch, sound, smell, and visual images in said brain of said victim. To identify the trigger for each region of the brain, a resonance frequency or set of resonance frequencies for the desired region of the brain must be decoded. Note that each person's brain has a unique set of resonance frequencies. However, for each said person's brain, each said resonance frequency, or each unique set of resonance frequencies, typically occurs within the vicinity of the corresponding resonance frequency in the table shown below.

| Brain | Resonance | Event Triggered |
|---|---|---|
| Region | Frequency | via Modulation |
| Somatosensory Cortex | 09 Hz | Induces Phantom Touch |
| Motor Control Cortex | 10 Hz | Induces Motor Coordination |
| Auditory Cortex | 15 Hz | Induces Sound which Bypasses Ears |
| Thought Center | 20 Hz | Induces Thoughts |
| Visual Cortex | 25 Hz | Induces Images which Bypasses Eyes |

Once decoded, said resonance frequency or set of resonance frequencies is modulated, in order to create the desired trigger event, in the desired region of the brain of said victim, corresponding to said resonance frequency or set of resonance frequencies. This modulation can be input into the brain of said victim at a plurality of intensities, from subliminal to perceptible.

1. A device, comprising:
a. a refreshable tactile display means operative to receive one or more control signals for controlling selectively movable tactile dots, and displaying therefrom tactile data to be read by a fingertip;
b. a motion sensing means operative to generate one or more signals indicative of an orientation in space, or a change of orientation in space;
c. a memory means operative to receive one or more control signals for controlling the location within said memory means, and to generate one or more signals corresponding to data stored at the location representative of said control signals;
d. a processor means having at least one input coupled to an output of the motion sensing means, the processor means receiving, via at least one bus, the one or more signals therefrom and generating corresponding control signals for controlling a location in said memory means, the processor means having at least one input coupled to an output of said memory means, the processor means receiving, via at least one bus, the one or more signals therefrom indicative of the data stored at the location, the processor means having at least one output coupled to said refreshable tactile display means and generating corresponding control signals output to said refreshable tactile display means, for displaying the data stored at the location corresponding to the motion;
whereby said device enables a user to read messages covertly, using the motion of said device to stream tactile messages across a reading finger making contact with the refreshable tactile display means, and to write messages covertly, using the motion of said device to stream selectable tactile text across a reading finger making contact with the refreshable tactile display means, and using a selection means, to select the desired text.

2. The device of claim 1, further including a transceiver means.

3. The device of claim 1, further including a fingernail-attachable holder means.

4. The device of claim 1, further including a camera means.

5. The device of claim 1, further including a transducer means.

6. The device of claim 1, further including a neural interface means.

7. The device of claim 1, further including a payment processing means.

8. The device of claim 1, wherein said device is encapsulated.

9. The device of claim 1, further including additional sensor means, and/or analyzer means, or a combination thereof.

10. The device of claim 1, wherein said device is a phone.

11. A neural interface means, comprising:
a. a neural sensor means operative to generate one or more signals indicative of brainwave emissions;
b. a transceiver means having at least one input coupled to an output of said neural sensor means, said transceiver means receiving, via at least one bus, the one or more signals therefrom and transmitting the one or more signals to a computing system, for processing;
c. a neural stimulator means operative to receive, from said transceiver means, and then transmit to a brain, one or more signals indicative of brainwave emissions, said transceiver means having at least one output coupled to the input of said neural stimulator means.
d. a power means operative to provide power to at least one means.

12. The device of claim 11, further including a refreshable tactile communications means.

13. The device of claim 11, further including a fingernail-attachable holder means.

14. The device of claim 11, further including a camera means.

15. The device of claim 11, further including a transducer means.

17. The device of claim 11, further including a payment processing means.

18. The device of claim 11, wherein said device is encapsulated.

19. The device of claim 11, further including additional sensor means, and/or analyzer means, or a combination thereof.

20. The device of claim 11, further including a memory means.

21. The device of claim 11, further including a processor means.
